(19) United States
(12) Patent Application Publication
(10) Pub. No.: US 2024/0372421 A1
(43) Pub. Date: Nov. 7, 2024

(54) E-MACHINE SYSTEM WITH STATOR CORE HAVING COOLING FLOW PASSAGES

(71) Applicant: Garrett Transportation I Inc., Torrance, CA (US)

(72) Inventors: Santosh Kumar Kuppa, Bangalore (IN); Petr Chmelicek, Brno (CZ)

(73) Assignee: Garrett Transportation I Inc., Torrance, CA (US)

(21) Appl. No.: 18/335,190

(22) Filed: Jun. 15, 2023

(30) Foreign Application Priority Data
May 4, 2023 (IN) 202311031714

(51) Int. Cl. H02K 1/20; H02K 9/19

(52) U.S. Cl. CPC H02K 1/20; H02K 9/19

(57) ABSTRACT

A stator core includes a first end and a second end separated along an axis. The stator core includes an inner radial surface and an outer radial surface. Also, the stator core includes an outer coolant groove defined on the outer radial surface of the stator core. The outer coolant groove extends about the axis. Additionally, the stator core includes a yoke flow channel extending through the stator core along the axis. The yoke flow channel is in fluid communication with the outer coolant groove. Furthermore, the outer coolant groove configured to receive coolant of the fluid coolant system and provide the coolant to the yoke flow channel, which provides the coolant to at least one of the first end and the second end.

### CROSS REFERENCE TO RELATED APPLICATION

This application claims priority to Indian Provisional Patent Application No. 202311031714, filed May 4, 2023, the entire content of which is incorporated by reference herein.

### TECHNICAL FIELD

The present disclosure relates, generally, to an e-machine system such as an electric motor system, electric generator system, and the like, and the present disclosure relates, more particularly, to an e-machine system with a stator core having cooling flow passages.

### BACKGROUND

E-machines, such as electric motors, electric generators, and combination motor/generators, are provided for a variety of uses. For example, electric traction motors are proposed for electric vehicles, locomotives, and the like.

Some e-machine systems may generate heat during operation, may operate in high-temperature environments, etc. Thus, e-machine systems are proposed that include cooling features. However, providing such cooling features remains challenging. There may be detrimental increases in costs, part count, device complexity, size, bulkiness, and/or weight if these cooling features are included.

Thus, there remains a need for an e-machine system that provides effective cooling. There remains a need for these e-machine systems, wherein the cooling features are provided in a relatively compact, low-weight package. There is also a need for such an e-machine system that also provides high manufacturing efficiency for reduced costs and manufacturing time.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a stator core is disclosed that is configured for an e-machine of an e-machine system. The stator core is configured to fluidly connect to a fluid coolant system of the e-machine system. The stator core includes a first end and a second end that is separated from the first end along an axis. The stator core includes an inner radial surface facing radially toward the axis and extending along the axis between the first end and the second end. The stator core further includes an outer radial surface facing radially away from the axis and extending along the axis between the first end and the second end. Also, the stator core includes an outer coolant groove defined on the outer radial surface of the stator core. The outer coolant groove extends about the axis. Additionally, the stator core includes a yoke flow channel extending through the stator core along the axis. The yoke flow channel is in fluid communication with the outer coolant groove. Furthermore, the outer coolant groove configured to receive coolant of the fluid coolant system and provide the coolant to the yoke flow channel, which provides the coolant to at least one of the first end and the second end.

In another embodiment, an e-machine system is disclosed that includes an e-machine with a stator member. The e-machine system includes a stator core of the stator member. Also, the e-machine system includes a fluid coolant system that is operatively connected to the stator core. The stator core includes a first end and a second end that is separated from the first end along an axis. The stator core also includes an inner radial surface facing radially toward the axis and extending along the axis between the first end and the second end and an outer radial surface facing radially away from the axis and extending along the axis between the first end and the second end. Moreover, the stator core includes an outer coolant groove defined on the outer radial surface of the stator core, the outer coolant groove extending about the axis. Furthermore, the stator core includes a yoke flow channel extending through the stator core along the axis, the yoke flow channel in fluid communication with the outer coolant groove. The outer coolant groove is configured to receive coolant of the fluid coolant system and provide the coolant to the yoke flow channel, which provides the coolant to at least one of the first end and the second end.

In a further embodiment, a stator core configured for an e-machine of an e-machine system is disclosed. The stator core is configured to fluidly connect to a fluid coolant system of the e-machine system. The stator core includes a first end and a second end that is separated from the first end along an axis. Also, the stator core includes an inner radial surface facing radially toward the axis and extending along the axis between the first end and the second end and an outer radial surface facing radially away from the axis and extending along the axis between the first end and the second end. Moreover, the stator core includes an outer coolant groove defined on the outer radial surface of the stator core, the outer coolant groove extending about the axis. Furthermore, the stator core includes a yoke flow channel extending through the stator core along the axis, the yoke flow channel in fluid communication with the outer coolant groove. The outer coolant groove is configured to receive coolant of the fluid coolant system and provide the coolant to the yoke flow channel, which provides the coolant to at least one of the first end and the second end. Additionally, the stator core includes a tooth flow channel extending through the stator core along the axis, the tooth flow channel configured to receive coolant of the fluid coolant system. Furthermore, the stator core includes a winding opening extending through the stator core along the axis, the winding opening configured to receive stator windings of the e-machine therein. The winding opening is disposed radially between the yoke flow channel and the tooth flow channel. The inner radial surface is smooth and continuous about the axis, and the outer radial surface has a cross section taken normal to the axis, the cross section being smooth and continuous.

Furthermore, other desirable features and characteristics of the present disclosure will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a schematic illustration of an e-machine system according to example embodiments of the present disclosure;

FIG. 2 is an end view of a stator core of the e-machine system according to example embodiments of the present disclosure;

FIG. 3 is a detail end view of the stator core of FIG. 2;

FIG. 4A is a side view of the stator core of FIG. 2;

FIG. 4B is a detail side view of the stator core of FIG. 4A;

FIG. 5 is a perspective view illustrating fluid flow through passages of the stator core of FIGS. 2-4B according to example embodiments; and

FIG. 6 is a perspective view illustrating fluid flow through additional passages of the stator core of FIGS. 2-4B according to example embodiments.

### DETAILED DESCRIPTION

The following detailed description is merely exemplary in nature and is not intended to limit the present disclosure or the application and uses of the present disclosure. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the present disclosure and not to limit the scope of the present disclosure, which is defined by the claims. Furthermore, there is no intention to be bound by any expressed or implied theory presented in the preceding technical field, background, brief summary, or the following detailed description.

Broadly, example embodiments disclosed herein include a stator arrangement of an e-machine that is in fluid communication within a fluid coolant system. The stator arrangement includes a stator core that may include a number of features fluidly connected within the fluid coolant system. The stator core may include one or more grooves, channels, tubes, openings, apertures, recesses, and/or other passages configured to receive a fluid coolant. These features may be arranged, shaped, positioned, etc. to direct flow of the coolant. Also, features may be fluidly connected to direct flow of the coolant about the stator core in a predetermined manner. These features of the stator core may also distribute the coolant about, within, over, and/or through the stator core for routing the coolant for effective cooling.

The stator core may include one or more outer coolant grooves defined on an outer radial surface of the stator core. The outer coolant groove(s) may extend about the axis of rotation of the motor (i.e., the axis of the stator core). The stator core may further include one or more yoke flow channels extending through the stator core along the axis. The yoke flow channel(s) may be in fluid communication with the outer coolant groove(s). Additionally, the stator core may include one or more tooth flow channels extending through the stator core along the axis. The stator core may also include one or more winding openings extending through the stator core along the axis, and the winding opening(s) may be configured to receive stator windings therein. The winding opening(s) may be disposed radially between the yoke flow channel(s) and the tooth flow channel(s).

The fluid coolant system may provide flow of a coolant that flows through a plurality of circumferentially-extending outer coolant grooves and axially along the yoke flow channels to the ends of the motor. In some embodiments, flow may be distributed amongst a plurality of the outer coolant grooves and a plurality of yoke flow channels due to fluid connections therebetween. Also, in some embodiments, flow through the yoke flow channels may be directed in both axial directions toward the ends of the stator core. Additionally, coolant may be provided to the tooth flow channels, and the coolant may flow generally in an axial direction through the stator core. In some embodiments, the coolant may flow in one direction from one end to the opposite end through the tooth flow channels. The coolant system may provide effective cooling for the motor. Also, the stator core may be manufactured efficiently.

Additionally, in some embodiments, an inner radial surface of the stator core (i.e., the surface opposing the rotor member of the e-machine) may be smooth and continuous about the axis. This may provide improved performance because the gap between the stator core and the rotor member may be substantially constant about the circumference of the stator/rotor interface.

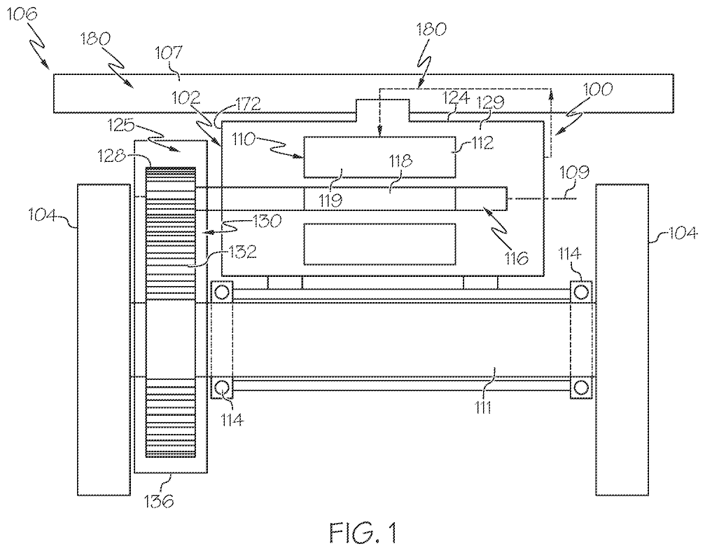

FIG. 1 is a schematic view of an e-machine system 100 according to example embodiments of the present disclosure. The e-machine system 100 may have a variety of configurations. In some embodiments, the e-machine system 100 may be configured as a traction drive system 102 that is included, for example, on a vehicle 106. Thus, the traction drive system 102 may be configured for driving one or more wheels 104 of the vehicle 106. More specifically, the wheels 104 may be included at opposite ends of an axle 111, and a chassis 107 may be supported on the wheels 104 by a suspension system (not shown). The vehicle 106 may be an electric car, truck, van, motorcycle, boat, or other vehicle. However, it will be appreciated that the e-machine system 100 may be configured otherwise without departing from the scope of the present disclosure.

Generally, the e-machine system 100 may include a housing 125. The housing 125 may include an e-machine housing 124 with a cavity 129 therein. The e-machine system 100 may also include an e-machine 110 that is received in the cavity 129 and housed within the e-machine housing 124.

The e-machine 110 may be an electric motor 112 in some embodiments. However, it will be appreciated that the e-machine 110 may be configured as an electric generator. Furthermore, the e-machine 110 may be operable in some modes as a motor and in additional modes as a generator. The e-machine 110 may include a rotor member 118 and a stator member 119 that are housed within the cavity 129 of the e-machine housing 124.

The rotor member 118 may be supported on a shaft 116, and the shaft 116 may be supported for rotation about an axis 109 (i.e., rotation axis 109) within the e-machine housing 124. The stator member 119 of the e-machine 110 may be fixed within the e-machine housing 124 and may surround the rotor member 118 and the shaft 116. In embodiments in which the e-machine 110 is an electric motor 112, the shaft 116 may be referred to as an output shaft 116 of the electric motor 112. In some embodiments, a gear connection member 128 (e.g., a gear, a spline on the shaft 116, or other part with gear teeth features) may be operably supported on the shaft 116.

Also, the e-machine system 100 may include a transmission 130. The transmission 130 may generally include a geartrain 132 that is housed within a gearbox housing 136 of the housing 125. The gearbox housing 136 may be attached (e.g., fixed) to a side wall 172 of the e-machine housing 124.

The geartrain 132 may be of any suitable type. The geartrain 132 may operatively connect the e-machine 110 and the axle 111 and may transmit power therebetween. The e-machine 110 may be coupled to the wheels 104 via the transmission 130. The geartrain 132 may be attached to the gear connection member 128 and to the axle 111. The gearbox housing 136 and the e-machine housing 124 may be moveably supported on the axle 111 by one or more bearings 114 (e.g., a bearing sleeve, suspension tube, etc.) such that the axle 111 may rotate relative thereto.

During operation, the electric motor 112 may rotatably drive the shaft 116 and the gear connection member 128 supported thereon. This rotational power may transfer to the geartrain 132, which may transmit the power to the axle 111 to rotate the wheels 104 and propel the vehicle 106.

Furthermore, the e-machine system 100 may include a fluid coolant system 180. The fluid coolant system 180 may be configured for circulating a fluid, such as a fluid coolant. The fluid may be a liquid, a coolant oil, etc.

The fluid coolant system 180 may be coupled to the stator member 119 as will be discussed. Accordingly, the fluid coolant system 180 and the stator member 119 may include features that provide cooling to the stator member 119. This may, in turn, provide cooling to the rotor member 118, to bearings, and/or to other adjacent areas of the e-machine 110.

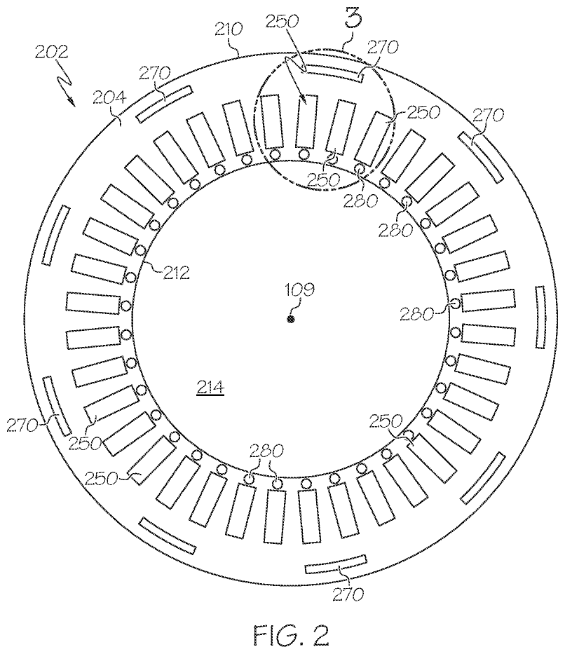

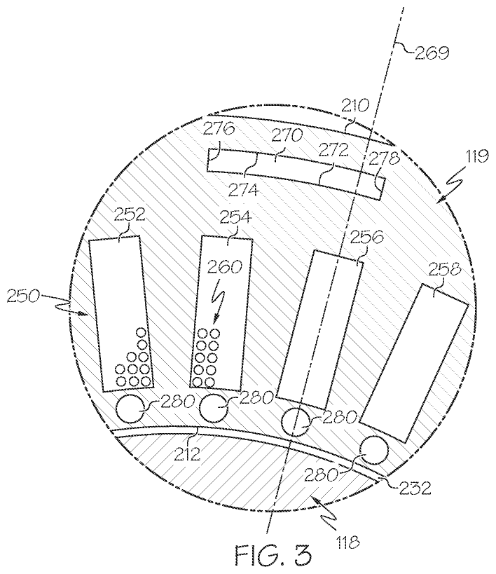

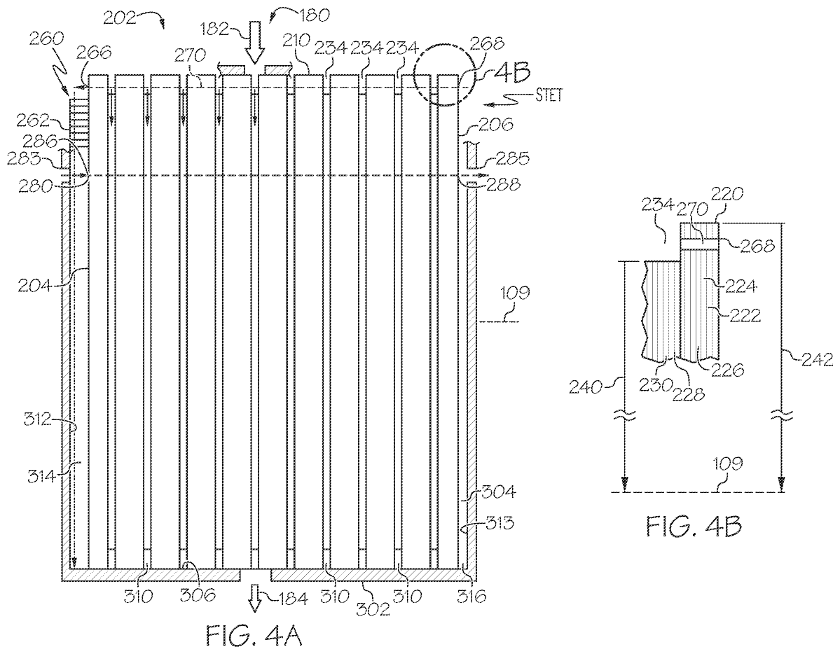

FIGS. 2-4B show a stator core 202 of the stator member 119 of the e-machine 110 according to example embodiments of the present disclosure. The stator core 202 may be generally cylindrical with a first end 204 and a second end 206 (FIG. 4A), which are separated along the axis 109. The stator core 202 may also include an outer radial surface 210 that extends about the axis 109 and that faces outwardly in a radial direction from the axis 109. Furthermore, the stator core 202 may be hollow and may include an inner radial surface 212 that extends about the axis 109 and that faces inwardly in the radial direction toward the axis 109. The inner radial surface 212 may define a central bore 214 (FIG. 2) that is centered on the axis 109 and that extends axially through the stator core 202. The central bore 214 may be sized and configured to receive the rotor member 118 as shown in FIG. 3.

As shown in FIG. 4B, the stator core 202 may comprise a plurality of (i.e., a stack of) stator laminations 220, 222, 224, 226, 228, 230. There may be any suitable number of stator laminations. The laminations 220-230 may be thin discs that are stacked together along the axis 109 to cooperatively define the stator core 202.

As shown in FIG. 2, the inner radial surface 212 may be smooth, continuous, annular, and uninterrupted in the circumferential direction about the axis 109. In some embodiments, the inner radial surface may have a smooth, continuous, circular cross section taken normal to the axis 109. There may be minor gaps between the laminations 220-230; however, the inner radial surface 212 may be otherwise smooth along a majority of the length of the stator core 202 as measured along the axis 109. This smooth inner radial surface 212 may provide improved performance for the e-machine system 100. For example, the smooth inner radial surface 212 may cooperate with the rotor member 118 to define a radial airgap 232 therebetween (FIG. 3). The smooth inner radial surface 212 may provide a more uniform airgap 232, which in turn may provide electromagnetic benefits.

As shown in FIGS. 4A and 4B, the outer radial surface 210 of the stator core 202 may include one or more outer grooves 234 defined thereon. In some embodiments, there may be a plurality of outer grooves 234 that extend in the circumferential direction about the axis 109. The outer grooves 234 may be continuous and annular in some embodiments. The outer grooves 234 may be spaced apart along the axis 109 on the outer radial surface 210. The outer grooves 234 may be recessed inward from surrounding areas of the outer radial surface 210.

As shown in FIG. 4B, the plurality of laminations 220-230 may have different radii from one another and may be arranged to define respective ones of the outer grooves 234. As shown, one or more laminations 220-230 may have a smaller outer radius than adjacent one(s) of the laminations 220-230 so as to define the respective outer groove 234. Specifically, as shown in FIG. 4B, the laminations 228, 230 may have a first outer radius 240 whereas the laminations 220, 222, 224, 226 may have a second outer radius 242 that is larger. Thus, the laminations 228, 230 (and other laminations like it) may define the respective outer groove 234.

Moreover, the stator core 202 may include a plurality of winding openings 250. The winding openings 250 may, in some embodiments, have a rectangular cross section taken normal to the axis 109. The winding openings 250 may extend continuously along the axis 109, through the stator core 202 from the first end 204 to the second end 206. Four of the winding openings 250 are illustrated in FIG. 3, namely, a first winding opening 252, a second winding opening 254, a third winding opening 256, and a fourth winding opening 258. The laminations 220-230 may include respective openings that are aligned axially to cooperatively define the winding openings 250 through the stator core 202. The winding openings 250 may be spaced apart at equal circumferential distances about the axis 109 as shown in FIG. 2. The winding openings 250 may be elongate in cross section (FIGS. 2 and 3) with the cross section elongated in the radial direction. The plurality of winding openings 250 may be arranged about the axis 109 so as to radiate from the axis 109 as shown.

The winding openings 250 may be shaped, sized, positioned, and otherwise configured to receive windings 260 of the stator member 119. A portion of the windings 260 is shown in FIGS. 3 and 4A. An end turn 262 of the windings 260 may extend outward from one of the winding openings (e.g., the first winding opening 252) and may turn back inward to be received in an adjacent winding opening (e.g., the second winding opening 254). There may be such end turns 262 at the first end 204 and the second end 206 of the stator core 202.

Moreover, the stator core 202 may include at least one yoke flow channels 270 that extends through the stator core 202 along the axis 109. The plurality of stator laminations 220-230 may include respective openings that collectively define the yoke flow channels 270. As shown, the stator core 202 may include a plurality of yoke flow channels 270 arranged about the axis 109. The plurality of yoke flow channels 270 may be spaced equally about the axis 109. The yoke flow channels 270 may be radially disposed proximate the outer radial surface 210 of the stator core 202 (FIGS. 2 and 3). As shown, there may be nine yoke flow channels 270 in some embodiments. There may be more or less yoke flow channels 270 in other embodiments.

As shown in FIGS. 2 and 3, the yoke flow channel(s) 270 may have cross section taken normal to the axis 109 with four sides. Specifically, as shown in FIG. 3, the yoke flow channel 270 may have an inner radial side 272, an outer radial side 274, a first side 276, and a second side 278. The cross section may be arcuately curved about the axis 109 such that the inner and outer radial sides 272, 274 are curved. Thus, in some embodiments, the yoke flow channels 270 may have arcuately-curved elongated cross sections taken normal to the axis 109. Also, the yoke flow channels 270 may be sized, shaped, positioned, etc. so as to align or overlap radially with at least one of the winding openings 250. For example, as shown in FIG. 3, one yoke flow channel 270 may radially overlap at least two adjacent ones of the winding openings 250.

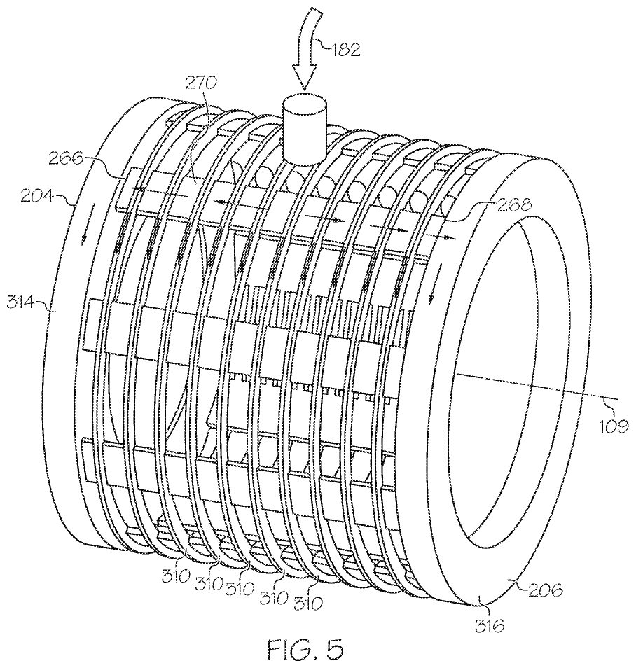

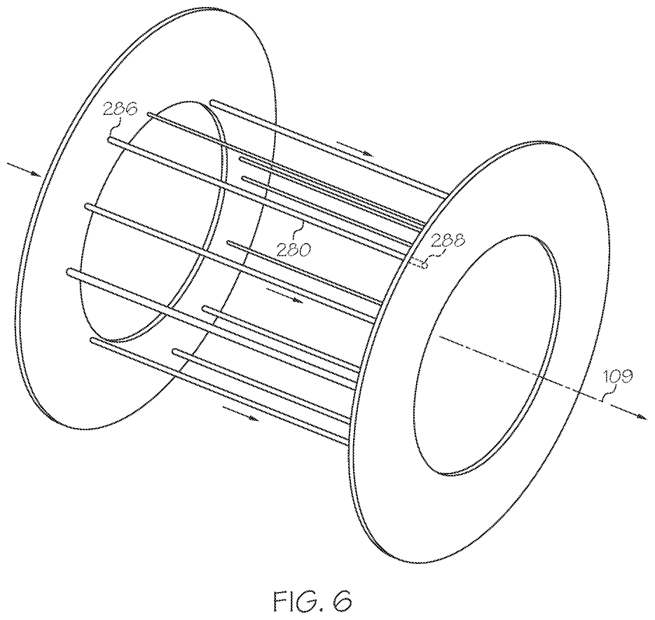

As shown in FIGS. 4A and 5, at least one yoke flow channel 270 may be axially straight and parallel to the axis 109. At least one yoke flow channel 270 may include a first end 266 that is open proximate the first end 204 of the stator core 202 and a second end 268 that is open proximate the second end 206 of the stator core 202. In some embodiments, each of the yoke flow channels 270 may include a respective open first end 266 and open second end 268.

As represented in FIG. 4A, the yoke flow channels 270 may be fluidly connected to the outer grooves 234 of the stator core 202. The outer grooves 234 may be recessed inwardly in the radial direction far enough so as to intersect and fluidly connect to the yoke flow channels 270. Stated differently, the yoke flow channels 270 and the outer grooves 234 may be disposed at a common radius so as to fluidly connect. In other words, the yoke flow channels 270 may be interrupted by the outer grooves 234.

The stator core 202 may further include at least one tooth flow channel 280 that extends through the stator core 202 along the axis 109. The plurality of stator laminations 220-230 may include respective openings that collectively define the tooth flow channels 280. As shown, there may be a plurality of tooth flow channels 280 arranged about the axis 109. The plurality of tooth flow channels 270 may be spaced equally about the axis 109. The tooth flow channels 280 may be radially disposed proximate the inner radial surface 212 of the stator core 202. Accordingly, the winding openings 250 may be disposed radially between the tooth flow channels 280 and the yoke flow channels 270. In some embodiments, the tooth flow channels 280 may be circular in cross section taken normal to the axis 109. The tooth flow channels 280 may have different cross sectional shapes (e.g., rectangular or otherwise polygonal) in other embodiments. In some embodiments, the tooth flow channels 280 may be aligned radially with respective ones of the winding openings 250 (i.e., substantially aligned in the same angular location, aligned along an imaginary, straight, radial line from the axis 109, etc.) with respect to the axis 109. Also, as shown in FIG. 3, an imaginary, straight, radial line 269 from the axis 109 may intersect at least one tooth flow channel 280, winding opening 256, and yoke flow channel 270 due to the angular positioning and “radial overlapping” of these features.

In some embodiments, the tooth flow channels 280 may extend continuously from the first end 204 to the second end 206 of the stator core. At least one tooth flow channel 280 may include a first end 286 that is open proximate the first end 204 of the stator core 202 and a second end 288 that is open proximate the second end 206 of the stator core 202. In some embodiments, each of the tooth flow channels 280 may include a respective open first end 286 and an open second end 288.

The tooth flow channels 280 may extend generally in the axial direction. In some embodiments, the tooth flow channels 280 may be axially straight. In some embodiments the tooth flow channels 280 may be substantially parallel to the axis 109.

The stator core 202 may be received in a motor housing 302 (FIG. 4A) of the e-machine housing 124. The motor housing 302 may include a motor cavity 304 that corresponds in shape with the stator core 202. The outer radial surface 210 may nest against an opposing inner radial surface 306 of the motor cavity 304. As such, the inner radial surface 306 and the outer grooves 234 may cooperatively define circumferential flow channels 310 that extend about the stator core 202.

Also, the first end 204 of the stator core 202 may face an opposing first axial inner surface 312 of the motor housing 302. The first end 204 may be spaced away from the first axial inner surface 312 so as to define at least one first end chamber 314. The first end chamber 314 may be annular and may receive the end turns 262. Likewise, the second end 206 of the stator core 202 may face an opposing second axial inner surface 313 of the motor housing 302. The second end 206 may be spaced away from the second axial inner surface 313 so as to define at least one second end chamber 316, which may be annular and may receive the end turns 262 at the second end 206.

The stator core 202 may be in fluid communication with and fluidly connected to the fluid coolant system 180. The fluid coolant system 180 may include at least one first fluid inlet 182 (FIGS. 4A and 5) that extends into the motor housing 302. The first fluid inlet 182 may be directed radially and may be disposed centrally along the axis 109. The fluid coolant system 180 may further include at least one first fluid outlet 184 (FIG. 4A) that extends out of the motor housing 302. The first fluid outlet 184 may be similarly positioned axially, but may be disposed on an opposite side of the axis 109 from the first fluid inlet 182. The first fluid inlet 182 and the first fluid outlet 184 may be fluidly connected to one or more of the circumferential flow channels 310. Accordingly, during operation coolant from the first fluid inlet 182 may flow about the stator core 202 in the circumferential flow channels 310. This fluid may reach one or more yoke flow channels 270 and may flow toward the first end 266 and the second end 268. Flow along the yoke flow channels 270 may also distribute the coolant to additional circumferential flow channels 310 positioned further in the axial direction. In the yoke flow channels 270, the fluid may flow from the first end 266 into the first end chamber 314 to cool the end turns 262, and fluid may also flow from the second end 268 into the second end chamber 316 to cool the other end turns 262 therein. This coolant may flow arcuately in the first and second end chambers 314, 316 and the coolant may outlet via the first fluid outlet 184. Coolant flow along these pathways may efficiently cool the stator core 202, the end turns 262, and/or other components of the e-machine 110.

As shown in FIG. 4A, the fluid coolant system 180 may further include at least one second fluid inlet 283 in the motor housing 302. The second fluid inlet 283 may extend through the housing 302 axially toward the first end 204 of the stator core 202. The second fluid inlet 283 may be fluidly connected to at least one first end 286 of the tooth flow channels 280 to provide the coolant thereto. The fluid coolant system 180 may additionally include at least one second outlet 285. The second outlet 285 may be fluidly connected to at least one second end 288 of the tool flow channels 280 to receive the coolant therefrom. Accordingly, during operation coolant from the second fluid inlet 283 may flow into at least one of the tooth flow channels 280 and may flow axially through the stator core 202 from the first end 286 to the second end 288 before exiting via the second outlet 285. This flow may provide additional cooling to the stator core 202, to the windings 260, to the rotor member 118, and/or other components of the e-machine system 100.

Accordingly, the stator core 202 of the present disclosure provides efficient cooling for the e-machine 110. The stator core 202 may also be compact and low weight. Furthermore, the stator core 202 may be manufactured efficiently for added advantage.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A stator core configured for an e-machine of an e-machine system, the stator core configured to fluidly connect to a fluid coolant system of the e-machine system, the stator core comprising:
a first end;
a second end that is separated from the first end along an axis;
an inner radial surface facing radially toward the axis and extending along the axis between the first end and the second end;
an outer radial surface facing radially away from the axis and extending along the axis between the first end and the second end;
an outer coolant groove defined on the outer radial surface of the stator core, the outer coolant groove extending about the axis;
a yoke flow channel extending through the stator core along the axis, the yoke flow channel in fluid communication with the outer coolant groove; and
the outer coolant groove configured to receive coolant of the fluid coolant system and provide the coolant to the yoke flow channel, which provides the coolant to at least one of the first end and the second end.

2. The stator core of claim 1, wherein the inner radial surface is smooth and continuous about the axis.

3. The stator core of claim 2, wherein the outer radial surface has a cross section taken normal to the axis, wherein the cross section is smooth and continuous.

4. The stator core of claim 1, further comprising a tooth flow channel extending through the stator core along the axis, the tooth flow channel configured to receive coolant of the fluid coolant system;
a winding opening extending through the stator core along the axis, the winding opening configured to receive stator windings of the e-machine therein; and
the winding opening disposed radially between the yoke flow channel and the tooth flow channel.

5. The stator core of claim 4, wherein the tooth flow channel has a cross section taken normal to the axis, wherein the cross section is substantially circular.

6. The stator core of claim 4, wherein the tooth flow channel extends axially straight through the stator core substantially parallel to the axis.

7. The stator core of claim 4, wherein the tooth flow channel is aligned radially with the winding opening with respect to the axis.

8. The stator core of claim 1, wherein the yoke flow channel has a cross section taken normal to the axis, the cross section being elongate in a circumferential direction about the axis.

9. The stator core of claim 8, wherein the cross section is elongate and arcuately curved about the axis.

10. The stator core of claim 9, further comprising a plurality of winding openings extending through the stator core along the axis, the plurality of winding openings configured to receive respective stator windings of the e-machine therein; and
wherein the yoke flow channel radially overlaps at least two adjacent ones of the plurality of winding openings.

11. The stator core of claim 1, wherein the yoke flow channel extends axially straight through the stator core substantially parallel to the axis.

12. The stator core of claim 1, wherein the yoke flow channel is one of a plurality of yoke flow channels that extend through the stator core along the axis, the plurality of yoke flow channels being in fluid communication with the outer coolant groove.

13. The stator core of claim 12, wherein the plurality of yoke flow channels are spaced substantially evenly about the axis.

14. The stator core of claim 13, further comprising a plurality of tooth flow channels extending through the stator core along the axis, the plurality of tooth flow channels configured to receive coolant of the fluid coolant system;
further comprising a plurality of winding openings extending through the stator core along the axis, the plurality of winding openings configured to receive respective stator windings of the e-machine therein; and
the plurality of winding openings disposed radially between the plurality of yoke flow channels and the plurality of tooth flow channels.

15. The stator core of claim 1, wherein the outer coolant groove extends annularly and continuously on the outer radial surface about the axis.

16. The stator core of claim 1, further comprising a plurality of laminations that are stacked along the axis to collectively define the outer radial surface, wherein different ones of the plurality of laminations have different radii, the different ones of the plurality of laminations cooperatively defining the outer coolant groove.

17. An e-machine system comprising:
an e-machine with a stator member;
a stator core of the stator member;
a fluid coolant system that is operatively connected to the stator core;
the stator core comprising:
a first end;
a second end that is separated from the first end along an axis;
an inner radial surface facing radially toward the axis and extending along the axis between the first end and the second end;
an outer radial surface facing radially away from the axis and extending along the axis between the first end and the second end;
an outer coolant groove defined on the outer radial surface of the stator core, the outer coolant groove extending about the axis;
a yoke flow channel extending through the stator core along the axis, the yoke flow channel in fluid communication with the outer coolant groove; and
the outer coolant groove configured to receive coolant of the fluid coolant system and provide the coolant to the yoke flow channel, which provides the coolant to at least one of the first end and the second end.

18. The e-machine system of claim 17, further comprising a tooth flow channel extending through the stator core along the axis, the tooth flow channel configured to receive coolant of the fluid coolant system;
a winding opening extending through the stator core along the axis, the winding opening configured to receive stator windings of the e-machine therein; and
the winding opening disposed radially between the yoke flow channel and the tooth flow channel.

19. The e-machine system of claim 18, further comprising a housing that defines a cavity that receives the stator core;
wherein the fluid coolant system includes a first inlet through the housing and a second inlet through the housing, the first inlet fluidly connected to the outer coolant groove to supply the coolant thereto, and the second inlet fluidly connected to the tooth flow channel to supply the coolant thereto.

20. A stator core configured for an e-machine of an e-machine system, the stator core configured to fluidly connect to a fluid coolant system of the e-machine system, the stator core comprising:
a first end;
a second end that is separated from the first end along an axis;
an inner radial surface facing radially toward the axis and extending along the axis between the first end and the second end;
an outer radial surface facing radially away from the axis and extending along the axis between the first end and the second end;
an outer coolant groove defined on the outer radial surface of the stator core, the outer coolant groove extending about the axis;
a yoke flow channel extending through the stator core along the axis, the yoke flow channel in fluid communication with the outer coolant groove;
the outer coolant groove configured to receive coolant of the fluid coolant system and provide the coolant to the yoke flow channel, which provides the coolant to at least one of the first end and the second end;
a tooth flow channel extending through the stator core along the axis, the tooth flow channel configured to receive coolant of the fluid coolant system;
a winding opening extending through the stator core along the axis, the winding opening configured to receive stator windings of the e-machine therein;
the winding opening disposed radially between the yoke flow channel and the tooth flow channel;
the inner radial surface being smooth and continuous about the axis; and
the outer radial surface having a cross section taken normal to the axis, the cross section being smooth and continuous.
